(19) United States
(12) Patent Application Publication
(10) Pub. No.: US 2017/0093182 A1
(43) Pub. Date: Mar. 30, 2017

(54) METHOD AND DEVICE FOR CHARGING MANAGEMENT

(71) Applicant: Xiaomi Inc., Beijing (CN)

(72) Inventors: Xiaoqin ZHANG, Beijing (CN); Hui DU, Beijing (CN); Linghua GU, Beijing (CN)

(73) Assignee: Xiaomi Inc.

(21) Appl. No.: 15/378,380

(22) Filed: Dec. 14, 2016

Related U.S. Application Data
(63) Continuation of application No. PCT/CN2015/077962, filed on Apr. 30, 2015.

(30) Foreign Application Priority Data
Dec. 16, 2014 (CN) 201410784711.2

(51) Int. Cl. H02J 7/00; G06F 1/28

(52) U.S. Cl. CPC H02J 7/007; G06F 1/28

(57) ABSTRACT

A charging management method for use in a mobile terminal, includes: acquiring a target charging current value and an actual charging current value during a charging process, the target charging current value being a desired electric current value set for the charging process; calculating a consumed current value according to the target charging current value and the actual charging current value; and adjusting the target charging current value according to the consumed current value.

### CROSS-REFERENCE TO RELATED APPLICATIONS

This application is a continuation of International Application No. PCT/CN2015/077962, filed Apr. 30, 2015, which is based upon and claims priority to Chinese Patent Application No. 201410784711.2, filed Dec. 16, 2014, the entire contents of all of which are incorporated herein by reference.

### TECHNICAL FIELD

The present disclosure generally relates to the field of electronic circuits and, more particularly, to a method and a device for charging management.

### BACKGROUND

As the computing capability of computer chips improves, the power consumption and heat generation of the chips are also growing. Thus, how to reduce the power consumption and heat generation in mobile terminals, such as smart phones, tablets, e-book readers, and the like, becomes an important subject.

In a mobile terminal, there are two major heat-generating chip sources. The first chip source includes the central processing unit (CPU), the graphic processing unit (GPU), and the memory. The second chip source includes the power management chip and the charging management chip. When a user is using the mobile terminal, the first chip source is the major heat generator. When the user is charging the mobile terminal, the second chip source is the major heat generator. When the user is using and charging the mobile terminal simultaneously, both chip sources generate a significant amount of heat. Such excessive heat may cause health hazard to the user or damage the mobile terminal.

### SUMMARY

According to a first aspect of the present disclosure, there is provided a charging management method for use in a mobile terminal, comprising: acquiring a target charging current value and an actual charging current value during a charging process, the target charging current value being a desired electric current value set for the charging process; calculating a consumed current value according to the target charging current value and the actual charging current value; and adjusting the target charging current value according to the consumed current value.

According to a second aspect of the present disclosure, there is provided a device for charging management, comprising: a processor; and a memory for storing instructions executable by the processor; wherein the processor is configured to perform: acquiring a target charging current value and an actual charging current value during a charging process, the target charging current value being a desired electric current value set for the charging process; calculating a consumed current value according to the target charging current value and the actual charging current value; and adjusting the target charging current value according to the consumed current value.

According to a third aspect of the present disclosure, there is provided a non-transitory computer-readable storage medium storing instructions that, when executed by a processor of a device, cause the device to perform a method for charging management, the method comprising: acquiring a target charging current value and an actual charging current value during a charging process, the target charging current value being a desired electric current value set for the charging process; calculating a consumed current value according to the target charging current value and the actual charging current value; and adjusting the target charging current value according to the consumed current value.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart of a method for charging management, according to an exemplary embodiment.

FIG. 2 is a flowchart of a method for charging management, according to an exemplary embodiment.

FIG. 3 is a flowchart of a method for charging management, according to an exemplary embodiment.

FIG. 4 is a block diagram of a device for charging management, according to an exemplary embodiment.

FIG. 5 is a block diagram of a device for charging management, according to an exemplary embodiment.

FIG. 6 is a block diagram of a device for charging management, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

In the embodiments of the present disclosure, a mobile terminal is an electronic device powered by a rechargeable battery. The mobile terminal may be a mobile phone, a tablet computer, an e-book reader, a moving picture experts group audio layer III (MP3) player, an MP4 player, a laptop computer, or the like.

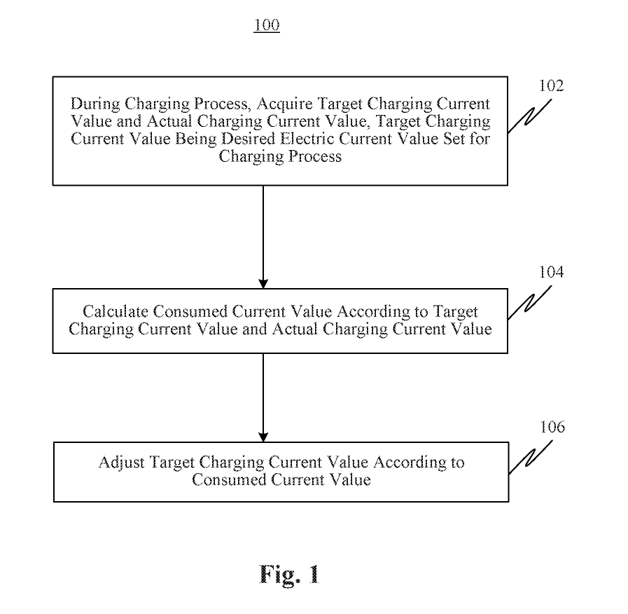

FIG. 1 is a flowchart of a method 100 for charging management, according to an exemplary embodiment. For example, the method 100 may be applied in a mobile terminal including at least one power supply, such as a rechargeable battery. The method 100 includes the following steps.

In step 102, during a charging process, the mobile terminal acquires a target charging current value and an actual charging current value.

The target charging current value is the desired value of the electric current for the charging process. The actual charging current value is the value of the actual electric current measured at the rechargeable battery. Typically, the actual charging current value is less than the target charging current value.

In step 104, the mobile terminal calculates a consumed current value according to the target charging current value and the actual charging current value.

The consumed current value is the difference of the target charging current value and the actual charging current value. The consumed current value is calculated according to the equation:

I_{consumed}=I_{target}−I_{actual} equation (1),

wherein the target charging current value, the actual charging current value, and the consumed current value are denoted by I_{target}, I_{actual}, and I_{consumed}, respectively.

The consumed current value measures the electric current consumed by the above-described first chip source in the mobile terminal, i.e., the current consumed by the CPU, the GPU, and the memory. A small consumed current value corresponds to a small load of the mobile terminal, and thus indicates that the user likely is not using the mobile terminal. A large consumed current value corresponds to a large load of the mobile terminal, and thus indicates that the user may be using the mobile terminal.

In step 106, the mobile terminal adjusts the target charging current value according to the consumed current value.

The target charging current value resulting from the adjustment is negatively correlated to the consumed current value. That is, if the consumed current value is small, the mobile terminal maintains a relatively large target charging current value to ensure the charging speed. If the consumed current value is large, the mobile terminal employs a relatively small target charging value to reduce heat generation.

The method 100 dynamically adjusts the target charging current value and thereby the heat generated by the mobile terminal, according to the consumed current value. In this manner, the mobile terminal can avoid generating excessive heat during a charging process.

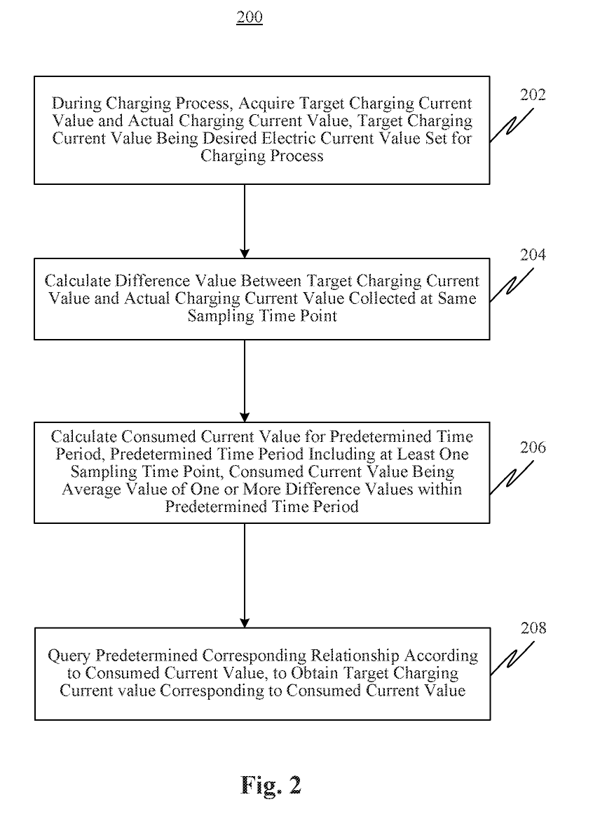

FIG. 2 is a flowchart of a method 200 for charging management, according to an exemplary embodiment. For example, the method 200 may be applied in a mobile terminal including at least one power supply, such as a rechargeable battery. The method 200 includes the following steps.

In step 202, during a charging process, the mobile terminal acquires a target charging current value and an actual charging current value. The target charging current value is the desired electric current value set for the charging process. The actual charging current is the actual electric current value measured at the rechargeable battery during the charging process.

During the charging process, the mobile terminal samples the target charging current value and the actual charging current value at a predetermined sampling frequency. For example, the mobile terminal may sample the currents once every 30 seconds. Table 1 shows an exemplary sampling result of the target charging current value and the actual charging current value.

TABLE 1
Sampling Result of Target Charging Current Value and Actual
Charging Current Value

| | Target Charging | Actual Charging |
|---|---|---|
| Sampling Schedule | Current Value | Current Value |
| Sampling Time Point 1 | Current Value 11 | Current Value 12 |
| Sampling Time Point 2 | Current Value 21 | Current Value 22 |
| Sampling Time Point 3 | Current Value 31 | Current Value 32 |
| Sampling Time Point 4 | Current Value 41 | Current Value 42 |

In step 204, the mobile terminal calculates a difference value between the target charging current value and the actual charging current value collected at the same sampling time point.

Each sampling time point is associated with a difference value. Table 2 shows an exemplary calculation process of the difference values at various sampling time points.

TABLE 2
Calculation of Difference Value Between Target Charging Current Value and Actual
Charging Current Value

| Sampling | Target Charging | Actual Charging | |
|---|---|---|---|
| Schedule | Current Value | Current Value | Difference Value |
| Sampling | Current Value 11 | Current Value 12 | Current Value 11 − Current Value 12 = |
| Time Point 1 | | | Current Value 13 |
| Sampling | Current Value 21 | Current Value 22 | Current Value 21 − Current Value 22 = |
| Time Point 2 | | | Current Value 23 |
| Sampling | Current Value 31 | Current Value 32 | Current Value 31 − Current Value 32 = |
| Time Point 3 | | | Current Value 33 |
| Sampling | Current Value 41 | Current Value 42 | Current Value 41 − Current Value 42 = |
| Time Point 4 | | | Current Value 43 |

In step 206, the mobile terminal calculates a consumed current value for a predetermined time period. The predetermined time period includes at least one sampling time point. The consumed current value is an average value of one or more difference values within the predetermined time period.

For example, if the mobile terminal samples the target charging current value and actual charging current value once every 30 seconds and the predetermined time period is 2 minutes, the predetermined time period includes 4 sampling time points. The mobile terminal may use at least one of the 4 sampling time points to calculate a difference value for the predetermined time period. Referring to Table 2, the consumed current value is set as the average value of the current value 13, the current value 23, the current value 33 and the current value 43.

In step 208, the mobile terminal obtains a target current value for the charging process according to a predetermined corresponding relationship between target charging current values and ranges of consumed current values.

The corresponding relationship includes at least one range of consumed current values and at least one target charging current value. Each range of consumed current values corresponds to a respective target charging current value. When performing step 208, the mobile terminal queries the corresponding relationship based on the consumed current value calculated in step 206, to obtain the target charging current value corresponding to the consumed current value.

In the corresponding relationship, the ranges of consumed current values are negatively correlated to the target charging current values. That is, as the consumed current value increases, the corresponding target charging current value decreases. Table 3 shows an exemplary corresponding relationship between the target charging current values and the ranges of the consumed current values.

TABLE 3
Corresponding Relationship Between Target Charging Current Values and
Ranges of Consumed Current Values

| Ranges of Consumed Current Values | Target Charging Current Values |
|---|---|
| (0, First Threshold) | Maximum Charging Current Value * |
| | 100% |
| (Second Threshold, Third Threshold) | Maximum Charging Current Value * |
| | 80% |
| (Third Threshold, Fourth Threshold) | Maximum Charging Current Value * |
| | 70% |
| (Fourth Threshold, Maximum Value) | Consumed Current Value |

Referring to Table 3, the first, second, third, and fourth thresholds are in ascending order. The maximum charging current value is a predetermined maximum allowable charging current value set for the mobile terminal. For example, when the consumed current value is smaller than the first threshold, the mobile terminal adjusts the target charging current value to be the maximum charging current value, and then continue the charging process according to the adjusted target charging current value. For another example, when the consumed current value is above the third threshold but below the fourth threshold, the mobile terminal adjusts the target charging current value to be 70% of the maximum charging current value, and then continues the charging process according to the adjusted target charging current value.

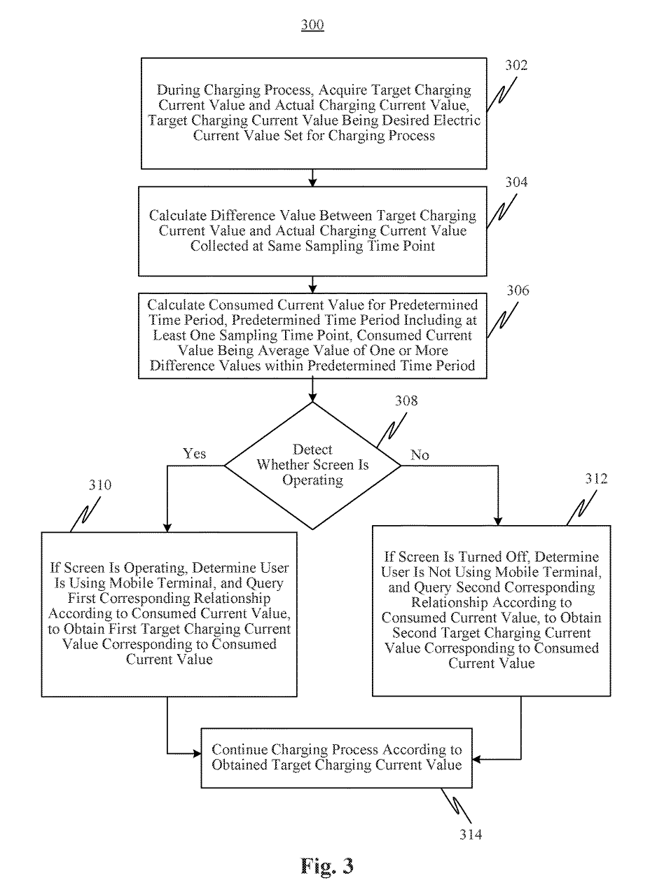

FIG. 3 is a flowchart of a method 300 for charging management, according to an exemplary embodiment. For example, the method 300 may be applied in a mobile terminal including at least one power supply, such as a rechargeable battery. The method 300 includes the following steps.

In step 302, during a charging process, the mobile terminal acquires a target charging current value and an actual charging current value. The target charging current value is a desired electric current value set for the charging process. The actual charging current value is the value of the actual electric current measured at the rechargeable battery.

During the charging process, the mobile terminal samples the target charging current value and the actual charging current value at a predetermined sampling frequency. For example, the mobile terminal may sample the target charging current value and the actual charging current value once every 30 seconds.

In step 304, the mobile terminal calculates a difference value between the target charging current value and the actual charging current value collected at the same sampling time point.

In step 306, the mobile terminal calculates a consumed current value for a predetermined time period. The predetermined time period includes at least one sampling time point. The consumed current value is an average value of one or more difference values within the predetermined time period.

For example, if the mobile terminal samples the target charging current value and actual charging current value once every 30 seconds and the predetermined time period is 2 minutes, the predetermined time period includes 4 sampling time points.

In step 308, the mobile terminal detects whether a screen of the mobile terminal is in an operating state.

The mobile terminal judges whether the user is using the mobile terminal by detecting whether the screen is in the operating state. If the screen is operating, step 310 is performed; and if the screen is turned off, step 312 is performed.

In exemplary embodiments, the mobile terminal pre-stores two sets of corresponding relationships between target charging current values and ranges of consumed current values, i.e., a first corresponding relationship and a second corresponding relationship. Each corresponding relationship includes at least one target charging current value and at least one range of consumed current values. Each range of consumed current values corresponds to a target charging current value.

For the same consumed current value, the corresponding target charging current value in the first corresponding relationship is less than or equal to the corresponding target charging current value in the second corresponding relationship. When the mobile terminal is used by the user, the mobile terminal determines the target charging current value according to the first corresponding relationship, to balance the heat generation and charging speed. When the mobile terminal is not used by the user, the mobile terminal determines the target charging current value according to the second corresponding relationship, to prioritize the charging speed.

In step 310, if the screen is in the operating state, the mobile terminal determines that the user is using the mobile terminal, and obtains a first target charging current value according to the first corresponding relationship between the target charging current values and the ranges of consumed current values.

In the first corresponding relationship, the ranges of consumed current values are negatively correlated to the target charging current values. Table 4 shows an exemplary first corresponding relationship.

TABLE 4
First Corresponding Relationship Between Target Charging Current
Values and Ranges of Consumed Current Values

| Range of Consumed Current Values | Target Charging Current Value |
|---|---|
| (0, 400 mA) | Maximum Charging Current Value * |
| | 100% |
| [400 mA, 700 mA) | Maximum Charging Current Value * |
| | 80% |
| [700 mA, 1100 mA) | Maximum Charging Current Value * |
| | 70% |
| [1100 mA, a maximum value) | Consumed Current Value |

Referring to Table 4, the maximum charging current value is a predetermined maximum allowable charging current value set for the mobile terminal. The mobile terminal queries the first corresponding relationship according to the consumed current value calculated in step 306, to obtain the corresponding target charging current value. For example, if the consumed current value is 500 mA, the mobile terminal adjusts the target charging current value to be 80% of the maximum charging current value.

In step 312, if the screen is in the turned-off state, the mobile terminal determines that the user is not using the mobile terminal, and obtains a second target charging current value according to the second corresponding relationship between the target charging current values and the ranges of consumed current values.

In the second corresponding relationship, the ranges of consumed current values are negatively correlated to the target charging current values. Table 5 shows an exemplary second corresponding relationship.

TABLE 5
Second Corresponding Relationship Between Target Charging Current
Values and Ranges of Consumed Current Values

| Ranges of Consumed Current Values | Target Charging Current Values |
|---|---|
| (0, 1000 mA) | Maximum Charging Current Value * |
| | 100% |
| [1000 mA, 1500 mA) | Maximum Charging Current Value * |
| | 90% |
| [1500 mA, Maximum Value) | Consumed Current Value |

Referring to Table 5, the maximum charging current value is a predetermined maximum allowable charging current value set for the mobile terminal. The maximum charging current value used in the first and second corresponding relationships may be the same value, or may be different values. The mobile terminal queries the second corresponding relationship according to the consumed current value calculated in step 306, to obtain the corresponding target charging current value. For example, if the consumed current value is 1100 mA, the mobile terminal adjusts the target charging current value to be 90% of the maximum charging current value.

In step 314, the mobile terminal continues the charging process according to the adjusted target charging current value.

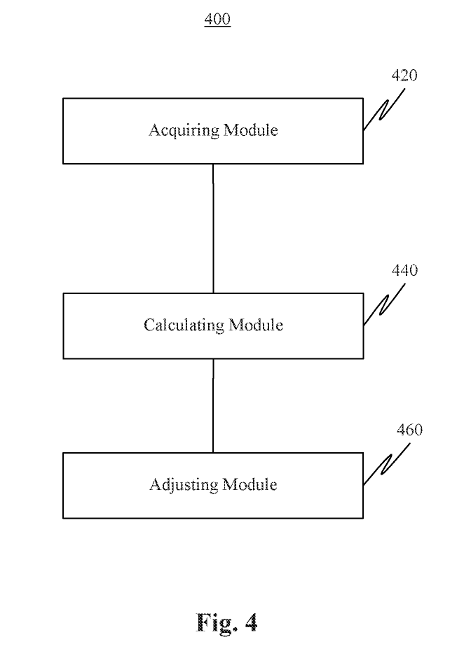

FIG. 4 is a block diagram of a device 400 for charging management, according to an exemplary embodiment. For example, the device 400 may be implemented by software, hardware, or a combination of both into a part of or whole of a mobile terminal. The mobile terminal includes at least one power supply, such as a rechargeable battery. Referring to FIG. 4, the device 400 includes an acquiring module 420, a calculating module 440, and an adjusting module 460.

The acquiring module 420 is configured to acquire a target charging current value and an actual charging current value during a charging process of the mobile terminal. The target charging current value is the desired electric current value set for a current charging process. The actual charging current value is the value of the actual electric current measured at the rechargeable battery.

The calculating module 440 is configured to calculate a consumed current value according to the target charging current value and the actual charging current value. The consumed current value is the difference of the target charging current value and the actual charging current value.

The adjusting module 460 is configured to adjust the target charging current value according to the consumed current value.

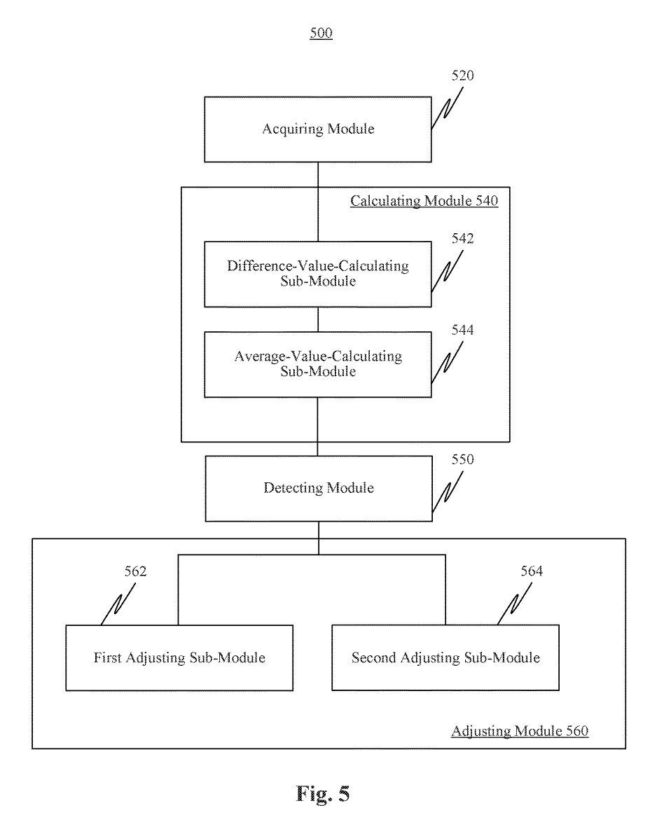

FIG. 5 is a block diagram of a device 500 for charging management, according to an exemplary embodiment. For example, the device 500 may be implemented by software, hardware, or a combination of both into a part of or whole of a mobile terminal. The mobile terminal includes at least one power supply, such as a rechargeable battery. The device 500 includes an acquiring module 520, a calculating module 540, and an adjusting module 560, similar to the acquiring module 420, the calculating module 440, and the adjusting module 460 (FIG. 4), respectively.

In exemplary embodiments, the calculating module 540 further includes a difference-value-calculating sub-module 542 and an average-value-calculating sub-module 544. The difference-value-calculating sub-module 542 is configured to calculate a difference value between the target charging current value and the actual charging current value collected by the acquiring module 520 at the same sampling time point. The average-value-calculating sub-module 544 is configured to calculate an average value of one or more difference values within a predetermined time period and set the average value as the consumed current value. The predetermined time period includes at least one sampling time point.

In exemplary embodiments, the adjusting module 560 is further configured to obtain a target current value corresponding to the consumed current value calculated by the calculating module 540, according to a predetermined corresponding relationship between target charging current values and ranges of consumed current values. The corresponding relationship includes at least one target charging current value and at least one range of consumed current values. Each range of consumed current values corresponds to a respective target charging current value. The adjusting module 460 queries the corresponding relationship according to the consumed current value, to obtain a corresponding target charging current value.

In exemplary embodiments, the adjusting module 560 further includes a first adjusting sub-module 562 and a second adjusting sub-module 564. The first adjusting sub-module 562 is configured to, when a user is using the mobile terminal, obtain a first target charging current value according to a first corresponding relationship between the target charging current values and the ranges of consumed current values. The second adjusting sub-module 564 is configured to, when the user is not using the mobile terminal, obtain a second target charging current value according to a second corresponding relationship between the target charging current values and the ranges of consumed current values.

Each of the first and second corresponding relationships includes at least one target charging current value and at least one range of consumed current values. Each range of consumed current values corresponds to a respective target charging current value. For the same consumed current value, the corresponding target charging current value in the first corresponding relationship is less than or equal to the corresponding target charging current value in the second corresponding relationship. The first adjusting sub-module 562 and the second adjusting sub-module 564 each query the respective corresponding relationship according to the consumed current value, to obtain the respective corresponding target charging current value.

In exemplary embodiments, in addition to the first adjusting sub-module 562 and second adjusting sub-module 564, the device 500 further includes a detecting module 550 configured to detect whether a screen of the mobile terminal is operating. The first adjusting sub-module 562 is further configured to determine that the user is using the mobile terminal if the detecting module 550 detects that the screen is operating. The second adjusting sub-module 564 is further configured to determine that the user is not using the mobile terminal if the detecting module 550 detects that the screen is not operating.

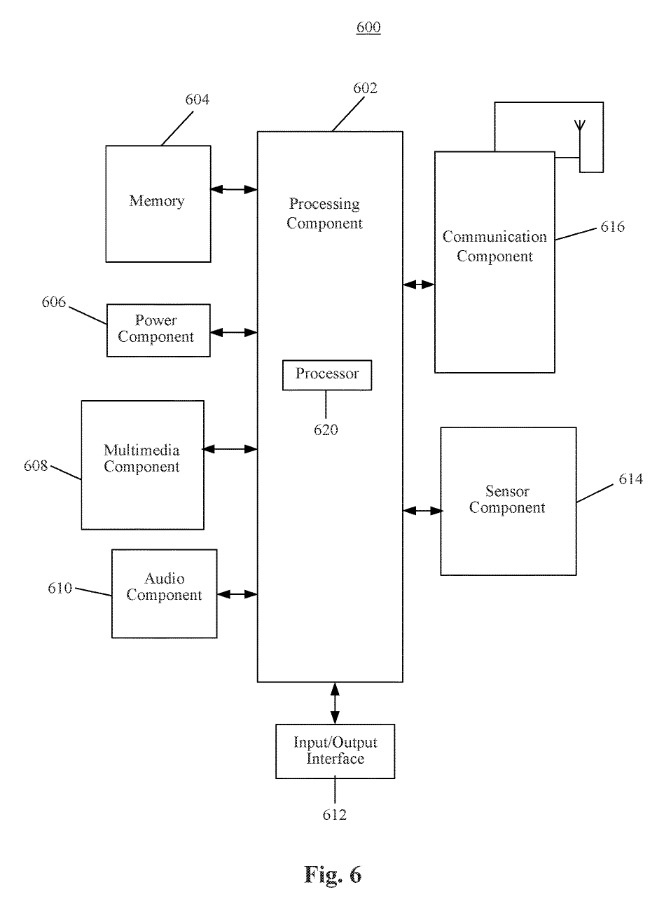

FIG. 6 is a block diagram of a device 600 for charging management, according to an exemplary embodiment. For example, the device 600 may be a mobile phone, a computer, a digital broadcast terminal, a messaging device, a gaming console, a tablet, a medical device, exercise equipment, a personal digital assistant, and the like.

Referring to FIG. 6, the device 600 may include one or more of the following components: a processing component 602, a memory 604, a power component 606, a multimedia component 608, an audio component 610, an input/output (I/O) interface 612, a sensor component 614, and a communication component 616.

The processing component 602 typically controls overall operations of the device 600, such as the operations associated with display, telephone calls, data communications, camera operations, and recording operations. The processing component 602 may include one or more processors 620 to execute instructions to perform all or part of the steps in the above-described methods. Moreover, the processing component 602 may include one or more modules which facilitate the interaction between the processing component 602 and other components. For instance, the processing component 602 may include a multimedia module to facilitate the interaction between the multimedia component 608 and the processing component 602.

The memory 604 is configured to store various types of data to support the operation of the device 600. Examples of such data include instructions for any applications or methods operated on the device 600, contact data, phonebook data, messages, pictures, videos, etc. The memory 604 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 606 provides power to various components of the device 600. The power component 606 may include a power management system, one or more power sources, and any other components associated with the generation, management, and distribution of power in the device 600.

The multimedia component 608 includes a screen providing an output interface between the device 600 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 608 includes a front camera and/or a rear camera. The front camera and the rear camera may receive an external multimedia datum while the device 600 is in an operation mode, such as a photographing mode or a video mode. Each of the front camera and the rear camera may be a fixed optical lens system or have focus and optical zoom capability.

The audio component 610 is configured to output and/or input audio signals. For example, the audio component 610 includes a microphone configured to receive an external audio signal when the device 600 is in an operation mode, such as a call mode, a recording mode, and a voice recognition mode. The received audio signal may be further stored in the memory 604 or transmitted via the communication component 616. In some embodiments, the audio component 610 further includes a speaker to output audio signals.

The I/O interface 612 provides an interface between the processing component 602 and peripheral interface modules, such as a keyboard, a click wheel, buttons, and the like. The buttons may include, but are not limited to, a home button, a volume button, a starting button, and a locking button.

The sensor component 614 includes one or more sensors to provide status assessments of various aspects of the device 600. For instance, the sensor component 614 may detect an open/closed status of the device 600, relative positioning of components, e.g., the display and the keypad, of the device 600, a change in position of the device 600 or a component of the device 600, a presence or absence of user contact with the device 600, an orientation or an acceleration/deceleration of the device 600, and a change in temperature of the device 600. The sensor component 614 may include a proximity sensor configured to detect the presence of nearby objects without any physical contact. The sensor component 614 may also include a light sensor, such as a CMOS or CCD image sensor, for use in imaging applications. In some embodiments, the sensor component 614 may also include an accelerometer sensor, a gyroscope sensor, a magnetic sensor, a pressure sensor, or a temperature sensor.

The communication component 616 is configured to facilitate communication, wired or wirelessly, between the device 600 and other devices. The device 600 can access a wireless network based on a communication standard, such as WiFi, 2G, 3G, 4G, or a combination thereof. In one exemplary embodiment, the communication component 616 receives a broadcast signal or broadcast associated information from an external broadcast management system via a broadcast channel In one exemplary embodiment, the communication component 616 further includes a near-field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 600 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above-described methods for charging management.

In exemplary embodiments, there is also provided a non-transitory computer-readable storage medium including instructions, such as included in the memory 604, executable by the processor 620 in the device 600, for performing the above-described methods. For example, the non-transitory computer-readable storage medium may be a ROM, a RAM, a CD-ROM, a magnetic tape, a floppy disc, an optical data storage device, and the like.

One of ordinary skill in the art will understand that the above-described modules can each be implemented by hardware, or software, or a combination of hardware and software. One of ordinary skill in the art will also understand that multiple ones of the above-described modules may be combined as one module, and each of the above-described modules may be further divided into a plurality of sub-modules.

Other embodiments of the present disclosure will be apparent to those skilled in the art from consideration of the specification and practice of the present disclosure. This application is intended to cover any variations, uses, or adaptations of the present disclosure following the general principles thereof and including such departures from the present disclosure as coming within known or customary practice in the art. It is intended that the specification and examples be considered as exemplary only, with a true scope and spirit of the invention being indicated by the following claims.

It will be appreciated that the present disclosure is not limited to the exact construction that has been described above and illustrated in the accompanying drawings, and that various modifications and changes can be made without departing from the scope thereof. It is intended that the scope of the invention only be limited by the appended claims.

What is claimed is:

1. A charging management method for use in a mobile terminal, comprising:
acquiring a target charging current value and an actual charging current value during a charging process, the target charging current value being a desired electric current value set for the charging process;
calculating a consumed current value according to the target charging current value and the actual charging current value; and
adjusting the target charging current value according to the consumed current value.

2. The method according to claim 1, wherein the adjusting of the target charging current value according to the consumed current value comprises:
obtaining a target charging current value corresponding to the consumed current value by querying, according to the consumed current value, a predetermined corresponding relationship between at least one target charging current value and at least one range of consumed current values.

3. The method according to claim 2, wherein the obtaining of the target charging current value corresponding to the consumed current value comprises:
when a user is using the mobile terminal, obtaining a first target charging current value corresponding to the consumed current value by querying, according to the consumed current value, a first corresponding relationship between at least one target charging current value and at least one range of consumed current values; and
when the user is not using the mobile terminal, obtaining a second target charging current value corresponding to the consumed current value by querying, according to the consumed current value, a second corresponding relationship between at least one target charging current value and at least one range of consumed current values;
wherein, for a same consumed current value, the first target charging current obtained from the first corresponding relationship is less than or equal to the second target charging current value obtained from the second corresponding relationship.

4. The method according to claim 3, wherein the mobile terminal includes a screen and the method further comprises:
detecting whether the screen is in an operating state;
if the screen is in the operating state, determining that the user is using the mobile terminal, and obtaining the first target charging current value by querying the first corresponding relationship; and
if the screen is in a turned-off state, determining that the user is not using the mobile terminal, and obtaining the second target charging current value by querying the second corresponding relationship.

5. The method according to claim 1, wherein the calculating of the consumed current value according to the target charging current value and the actual charging current value comprises:
calculating a difference value between the target charging current value and the actual charging current value, the target charging current value and the actual charging current value being collected at a same sampling time point; and
calculating the consumed current value for a predetermined time period, the predetermined time period including at least one sampling time point and the consumed current value being an average value of one or more difference values within the predetermined time period.

6. The method according to claim 2, wherein the calculating of the consumed current value according to the target charging current value and the actual charging current value comprises:
calculating a difference value between the target charging current value and the actual charging current value, the target charging current value and the actual charging current value being collected at a same sampling time point; and
calculating the consumed current value for a predetermined time period, the predetermined time period including at least one sampling time point and the consumed current value being an average value of one or more difference values within the predetermined time period.

7. The method according to claim 3, wherein the calculating of the consumed current value according to the target charging current value and the actual charging current value comprises:
calculating a difference value between the target charging current value and the actual charging current value, the target charging current value and the actual charging current value being collected at a same sampling time point; and
calculating the consumed current value for a predetermined time period, the predetermined time period including at least one sampling time point and the consumed current value being an average value of one or more difference values within the predetermined time period.

8. The method according to claim 4, wherein the calculating of the consumed current value according to the target charging current value and the actual charging current value comprises:
calculating a difference value between the target charging current value and the actual charging current value, the target charging current value and the actual charging current value being collected at a same sampling time point; and
calculating the consumed current value for a predetermined time period, the predetermined time period including at least one sampling time point and the consumed current value being an average value of one or more difference values within the predetermined time period.

9. A device for charging management, comprising:
a processor; and
a memory for storing instructions executable by the processor;
wherein the processor is configured to perform:
acquiring a target charging current value and an actual charging current value during a charging process, the target charging current value being a desired electric current value set for the charging process;
calculating a consumed current value according to the target charging current value and the actual charging current value; and
adjusting the target charging current value according to the consumed current value.

10. The device for charge management according to claim 9, wherein the processor is further configured to perform:
obtaining a target charging current value corresponding to the consumed current value by querying, according to the consumed current value, a predetermined corresponding relationship between at least one target charging current value and at least one range of consumed current values.

11. The device for charge management according to claim 10, wherein the processor is configured to perform:
when a user is using the device, obtaining a first target charging current value corresponding to the consumed current value by querying, according to the consumed current value, a first corresponding relationship between at least one target charging current value and at least one range of consumed current values; and
the user is not using the device, obtaining a second target charging current value corresponding to the consumed current value by querying, according to the consumed current value, a second corresponding relationship between at least one target charging current value and at least one range of consumed current values;
wherein, for a same consumed current value, the first target charging current value obtained from the first corresponding relationship is less than or equal to the second target charging current value obtained from the second corresponding relationship.

12. The device for charge management according to claim 11, wherein the device includes a screen and the processor is further configured to perform:
detecting whether the screen is in an operating state;
if the screen is in the operating state, determining that the user is using the device, and obtaining the first target charging current value by querying the first corresponding relationship; and
if the screen is in a turned-off state, determining that the user is not using the device, and obtaining the second target charging current value by querying the second corresponding relationship.

13. The device for charging management according to claim 9, wherein the processor is further configured to perform:
calculating a difference value between the target charging current value and the actual charging current value, the target charging current value and the actual charging current value being collected at a same sampling time point; and
calculating the consumed current value for a predetermined time period, the predetermined time period including at least one sampling time point and the consumed current value being an average value of one or more difference values within the predetermined time period.

14. The device for charging management according to claim 10, wherein the processor is further configured to perform:
calculating a difference value between the target charging current value and the actual charging current value, the target charging current value and the actual charging current value being collected at a same sampling time point; and
calculating the consumed current value for a predetermined time period, the predetermined time period including at least one sampling time point and the consumed current value being an average value of one or more difference values within the predetermined time period.

15. The device for charging management according to claim 11, wherein the processor is further configured to:
calculating a difference value between the target charging current value and the actual charging current value, the target charging current value and the actual charging current value being collected at the same sampling time point; and
calculating the consumed current value for a predetermined time period, the predetermined time period including at least one sampling time point and the consumed current value being an average value of one or more difference values within the predetermined time period.

16. The device for charging management according to claim 12, wherein the processor is further configured to perform:
calculating a difference value between the target charging current value and the actual charging current value, the target charging current value and the actual charging current value being collected at the same sampling time point; and
calculating the consumed current value for a predetermined time period, the predetermined time period including at least one sampling time point and the consumed current value being an average value of one or more difference values within the predetermined time period.

17. A non-transitory computer-readable storage medium storing instructions that, when executed by a processor of a device, cause the device to perform a method for charging management, the method comprising:
acquiring a target charging current value and an actual charging current value during a charging process, the target charging current value being a desired electric current value set for the charging process;
calculating a consumed current value according to the target charging current value and the actual charging current value; and
adjusting the target charging current value according to the consumed current value.

18. The medium according to claim 17, wherein the adjusting of the target charging current value according to the consumed current value comprises:
obtaining a target charging current value corresponding to the consumed current value by querying, according to the consumed current value, a predetermined corresponding relationship between at least one target charging current value and at least one range of consumed current values.

19. The medium according to claim 18, wherein the obtaining of the target charging current value corresponding to the consumed current value comprises:
when a user is using the mobile terminal, obtaining a first target charging current value corresponding to the consumed current value by querying, according to the consumed current value, a first corresponding relationship between at least one target charging current value and at least one range of consumed current values; and
when the user is not using the mobile terminal, obtaining a second target charging current value corresponding to the consumed current value by querying, according to the consumed current value, a second corresponding relationship between at least one target charging current value and at least one range of consumed current values;
wherein, for a same consumed current value, the first target charging current obtained from the first corresponding relationship is less than or equal to the second target charging current value obtained from the second corresponding relationship.

20. The medium according to claim 19, wherein the mobile terminal includes a screen and the method further comprises:
detecting whether the screen is in an operating state;
if the screen is in the operating state, determining that the user is using the mobile terminal, and obtaining the first target charging current value by querying the first corresponding relationship; and
if the screen is in a turned-off state, determining that the user is not using the mobile terminal, and obtaining the second target charging current value by querying the second corresponding relationship.
